(19) United States
(12) Patent Application Publication
(10) Pub. No.: US 2025/0256688 A1
(43) Pub. Date: Aug. 14, 2025

(54) DOLLY APPARATUSES INCLUDING SYNCHRONIZATION DEVICES

(71) Applicant: Toyota Motor Engineering & Manufacturing North America, Inc., Plano, TX (US)

(72) Inventors: Lloyd R. Holland, Georgetown, KY (US); Scottie L. Foster, Lawrenceburg, KY (US); Bradley J. Garcia, Louisville, KY (US); Michael C. Greenlee, Paris, KY (US); Jeffrey L. James, Mount Sterling, KY (US); Jason E. Anderson, Lexington, KY (US); Patrick J. Cornish, Georgetown, KY (US); Christopher M. Peak, Stanton, KY (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/438,016

(22) Filed: Feb. 9, 2024

(51) Int. Cl. B60S 9/00; B60B 27/00; B62D 51/04

(52) U.S. Cl. CPC B60S 9/00; B60B 27/0015; B62D 51/04

(57) ABSTRACT

A dolly apparatus for use on an assembly line includes a frame and a synchronization device mounted to the frame. The synchronization device includes a body that mounts to the frame and a synchronization leg that is configured to move up and down relative to the body. The synchronization leg includes a foot that is configured to seat against a conveyor with the synchronization leg is a lowered position. A pedal is operatively linked to the synchronization leg such that downward movement of the pedal toward an actuated position moves the synchronization leg from a raised position to the lowered position. A release plate is operatively linked to the pedal such that movement of the release plate from a locked position to a release position causes the pedal to move from the actuated position toward an initial position to raise the synchronization leg toward the raised position.

### TECHNICAL FIELD

The present specification generally relates to dolly apparatuses for an assembly line and, more specifically, to dolly apparatuses that include synchronization devices for synchronizing movement with conveyors.

### BACKGROUND

Dolly apparatuses may be used on an assembly line, such as a vehicle assembly line. Dolly apparatuses are currently used that synchronize with a moving conveyor using pneumatic or electric cylinders by engaging a structure, such as part of a vehicle assembly, as it moves closer to the dolly apparatus.

What is needed are dolly apparatuses that include synchronization devices for synchronizing movement with conveyors.

### SUMMARY

In one embodiment, a dolly apparatus for use on an assembly line includes a frame and a synchronization device mounted to the frame. The synchronization device includes a body that mounts to the frame and a synchronization leg that is configured to move up and down relative to the body. The synchronization leg includes a foot that is configured to seat against a conveyor with the synchronization leg is a lowered position. A pedal is operatively linked to the synchronization leg such that downward movement of the pedal toward an actuated position moves the synchronization leg from a raised position to the lowered position. A release plate is operatively linked to the pedal such that movement of the release plate from a locked position to a release position causes the pedal to move from the actuated position toward an initial position to raise the synchronization leg toward the raised position.

In another embodiment, a dolly apparatus for use on an assembly line includes a frame and a synchronization device mounted to the frame. The synchronization device includes a body that mounts to the frame and a synchronization leg that is configured to move up and down relative to the body, the synchronization leg comprising a foot configured to seat against a conveyor with the synchronization leg is a lowered position. A pedal is operatively linked to the synchronization leg such that downward movement of the pedal toward an actuated position moves the synchronization leg from a raised position to the lowered position. A drive wheel assembly includes a drive wheel that is biased and configured to rotate automatically such that the dolly apparatus moves with the synchronization leg in the raised position.

In another embodiment, a method of automatically moving a dolly apparatus from an initial location to a downstream location is provided. The method includes engaging a conveyor with a synchronization leg of a dolly apparatus such that the dolly apparatus moves with the component. The dolly apparatus includes a frame and a synchronization device mounted to the frame. The synchronization device includes a body that mounts to the frame and a synchronization leg that is configured to move up and down relative to the body. The synchronization leg includes a foot that is configured to seat against a conveyor with the synchronization leg is a lowered position. A pedal is operatively linked to the synchronization leg such that downward movement of the pedal toward an actuated position moves the synchronization leg from a raised position to the lowered position. A release plate is operatively linked to the pedal such that movement of the release plate from a locked position to a release position causes the pedal to move from the actuated position toward an initial position to raise the synchronization leg toward the raised position. The release plate is actuated thereby raising the synchronization leg to the raised position and the synchronization leg releasing the conveyor.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a diagrammatic view of a vehicle assembly line system including a dolly apparatus including a synchronization device, according to one or more embodiments shown and described herein;

FIG. 2 is a diagrammatic view of the synchronization device of FIG. 1, according to one or more embodiments shown and described herein;

FIG. 3 is a diagrammatic view of the dolly apparatus of FIG. 1 in use, according to one or more embodiments shown and described herein; and

FIG. 4 is a diagrammatic view of the dolly apparatus of FIG. 1 in use, according to one or more embodiments shown and described herein.

### DETAILED DESCRIPTION

Embodiments described herein are generally related to dolly apparatuses with synchronization devices that synchronize with a conveyor system to travel therewith in a conveying direction. The dolly apparatuses include a frame and a synchronization device mounted to the frame. The synchronization device includes a body that mounts to the frame and a synchronization leg that is configured to move up and down relative to the body. The synchronization leg comprising a foot configured to seat against a conveyor with the synchronization leg is a lowered position. A pedal is operatively linked to the synchronization leg such that downward movement of the pedal toward an actuated position moves the synchronization leg from a raised position to the lowered position. A release plate is operatively linked to the pedal such that movement of the release plate from a locked position to a release position causes the pedal to move from the actuated position toward an initial position to raise the synchronization leg from the lowered position toward the raised position.

The dolly apparatuses may be used on a vehicle assembly line, as an example. The dolly apparatus may be a wheeled device that is moveable along a conveyor that conveys a vehicle part, such as a part of a vehicle in a conveying direction. The dolly apparatus can synchronize with the conveyor to move in the conveying direction with the vehicle part during an assembly process. Once the assembly process is complete, the dolly apparatus may be uncoupled from the conveyor and then moved in an upstream direction past the vehicle part and toward a next vehicle part for another assembly process. The pedal moves the synchronization leg between the raised position disengaged with the conveyor and a lowered position out engaged with the conveyor. Once the synchronization leg is lowered to the lowered position, the foot can engage the conveyor and the pedal can lock into place. The release plate can then be used to release the pedal and allow the synchronization leg to return to the raised position.

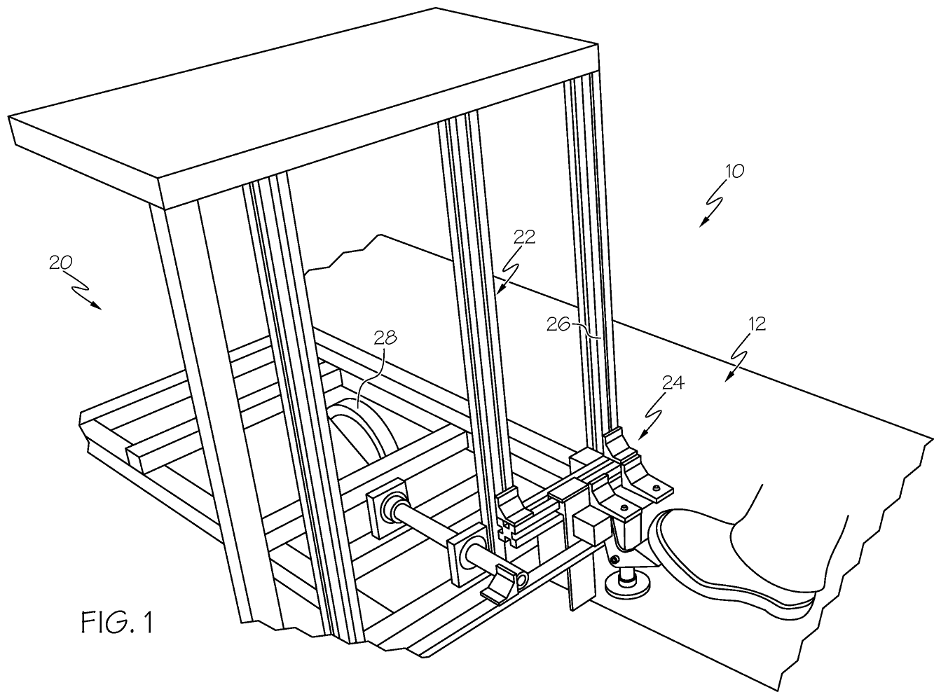

Referring to FIG. 1, an assembly line system 10 generally includes a conveyor (denoted by element 12). A dolly apparatus 20 includes a frame 22 and a synchronization device 24 mounted to the frame 22. In particular, the synchronization device 24 is mounted to one or more support beam 26 of the frame 22. A plurality of wheels 28 may be provided rotatably mounted to the frame 22 that allows the dolly apparatus 20 to move along the conveyor 12, for example, in upstream and downstream directions.

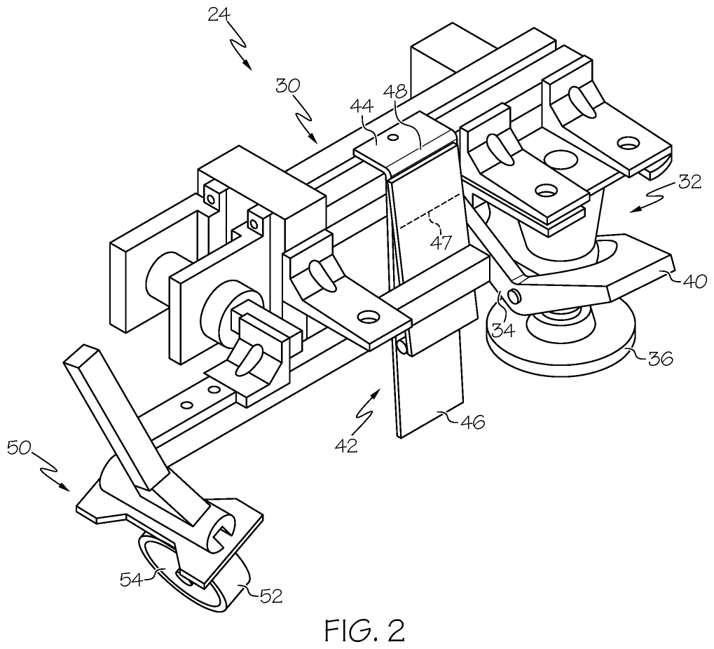

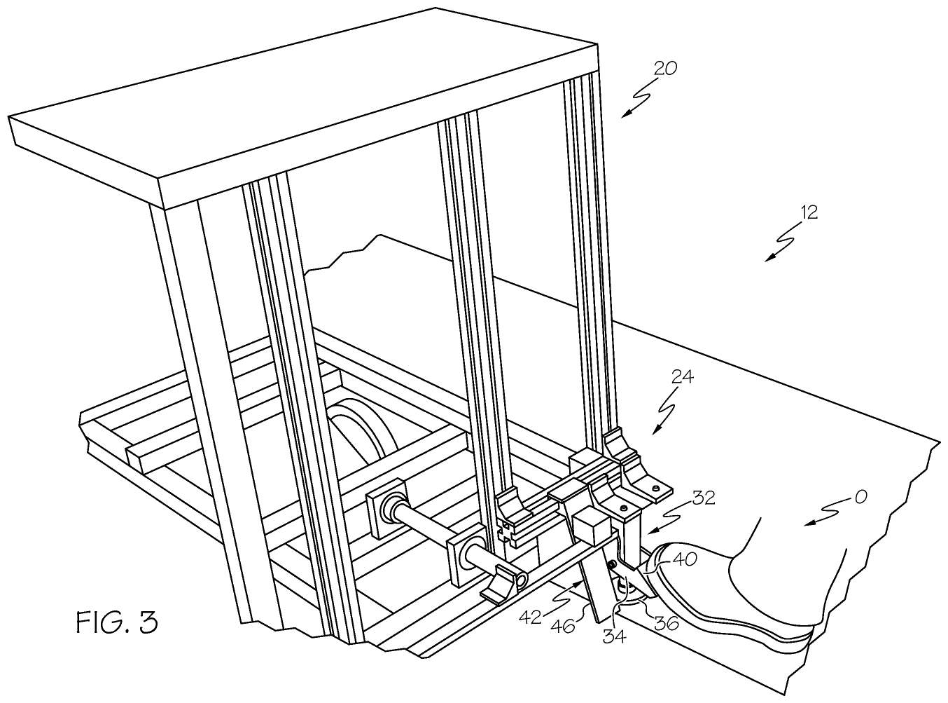

Referring to FIG. 2, the synchronization device 24 includes a body 30 that mounts to the base support beam 26 of the frame 22. A synchronization leg 32 is movably mounted to the body 30, for example, using a linkage arm 34 so that the synchronization leg 32 can move up and down relative to the body 30. The synchronization leg 32 includes a foot 36 that is configured to seat against the conveyor 12 with the synchronization leg 32 in a lowered position (FIG. 3). The linkage arm 34 is connected to a pedal 40 that is operatively linked to the synchronization leg 32. Downward movement of the pedal 40 toward an actuated position (FIG. 3) moves the synchronization leg 32 from a raised position to the lowered position. The linkage arm 34 may be configured to lock, for example, using a hinged connection, with the pedal in the actuated position until a force is applied to the linkage arm 34.

A release plate 42 is operatively linked to the pedal 40 via the linkage arm 34. The release plate 42 is mounted to the body 30 using a mount portion 44 and a kick portion 46 is movably mounted to the mount portion 44 at a hinge 48. Pressing the pedal 40 to the actuated position causes the kick portion 46 to rotate outward using the hinge 48 to a locked position. Movement of the kick portion 46 from the locked position to a release position causes the linkage arm 34 operatively connected thereto (e.g., by a rod 47 behind the kick portion 46) to move and thereby moves the pedal 40 from the actuated position toward an initial position to raise the synchronization leg 32 toward the raised position.

A drive wheel assembly 50 may be connected to the body 30. For example, the drive wheel assembly 50 may be a spring-powered wheel assembly that is configured to rotate a drive wheel 52 automatically to push the dolly apparatus 20 back toward an initial position. A torsion spring, represented by element 54, for example, may be wound as the dolly apparatus 20 moves under an applied force and then unwinds to rotate the drive wheel 52 automatically when the dolly apparatus 20 is released from the applied force.

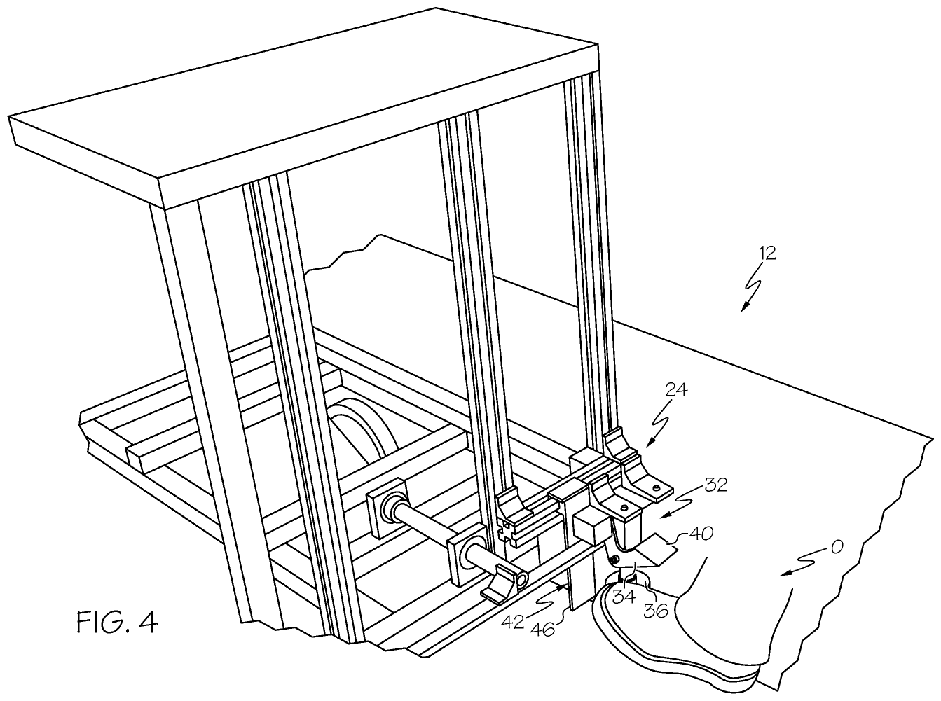

FIGS. 3 and 4 illustrate operation of the synchronization device 24 connected to the dolly apparatus 20. Referring first to FIG. 3, the dolly apparatus is moved to a desired location along the conveyor 12. When the desired location is reached, the operator O places a foot on the pedal 40 and pushes the pedal 40 down, which causes the synchronization leg 32 to lower, the foot 36 to engage the conveyor 12 and the linkage arm 34 to lock with the synchronization leg 32 in the lowered position. The dolly apparatus 20 can then move along the assembly line system 10 with the conveyor 12 until an assembly operation is completed. Once completed, the operator O may then push the release plate 42 using the foot which moves the kick portion 46 rearward and causes the linkage arm 34 to unlock and the pedal 40 to raise thereby raising the synchronization leg 32 as shown by FIG. 4. Referring to FIG. 2, the drive wheel assembly 50 can then cause the dolly apparatus 20 to move upstream toward the initial position of the dolly apparatus 20.

The above-described dolly apparatuses include synchronization devices that include a synchronization leg that can be lowered and locked in place against a conveyor so that the dolly apparatus can synchronize and move along with the conveyor. When an assembly operation is completed, the operator can kick the release plate to release the synchronization leg from the conveyor. The dolly apparatuses can then travel back toward their initial position using a spring-loaded drive wheel. The dolly apparatuses can travel downstream in the conveying direction so that the dolly apparatus returns to its initial location under the biasing force without the need for the operator to travel with the dolly apparatus. Such an automatic return arrangement can reduce or even eliminate walking time for the operator between assembly operations.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A dolly apparatus for use on an assembly line, the dolly apparatus comprising:
a frame; and
a synchronization device mounted to the frame, the synchronization device comprising:
a body that mounts to the frame;
a synchronization leg configured to move up and down relative to the body, the synchronization leg comprising a foot configured to seat against a conveyor with the synchronization leg is a lowered position;
a pedal operatively linked to the synchronization leg such that downward movement of the pedal toward an actuated position moves the synchronization leg from a raised position to the lowered position; and
a release plate that is operatively linked to the pedal such that movement of the release plate from a locked position to a release position causes the pedal to move from the actuated position toward an initial position to raise the synchronization leg toward the raised position.

2. The dolly apparatus of claim 1 further comprising a drive wheel assembly comprising a drive wheel that is biased and configured to rotate automatically such that the dolly apparatus moves with the synchronization leg in the raised position.

3. The dolly apparatus of claim 2, wherein the drive wheel is spring-biased to rotate automatically.

4. The dolly apparatus of claim 2, wherein the synchronization device comprises the drive wheel assembly.

5. The dolly apparatus of claim 1, wherein the release plate comprises a mount portion that is mounted to the body and a kick portion that is attached to the mount portion by a hinge.

6. The dolly apparatus of claim 1, wherein the release plate is operatively connected to the pedal by a linkage arm.

7. A dolly apparatus for use on an assembly line, the dolly apparatus comprising:
a frame; and
a synchronization device mounted to the frame, the synchronization device comprising:
a body that mounts to the frame;
a synchronization leg configured to move up and down relative to the body, the synchronization leg comprising a foot configured to seat against a conveyor with the synchronization leg is a lowered position;
a pedal operatively linked to the synchronization leg such that downward movement of the pedal toward an actuated position moves the synchronization leg from a raised position to the lowered position; and
a drive wheel assembly comprising a drive wheel that is biased and configured to rotate automatically such that the dolly apparatus moves with the synchronization leg in the raised position.

8. The dolly apparatus of claim 7 further comprising a drive wheel assembly comprising a drive wheel that is biased and configured to rotate automatically such that the dolly apparatus moves with the synchronization leg in the raised position.

9. The dolly apparatus of claim 8, wherein the drive wheel is spring-biased to rotate automatically.

10. The dolly apparatus of claim 8, wherein the synchronization device comprises the drive wheel assembly.

11. The dolly apparatus of claim 7, wherein the release plate comprises a mount portion that is mounted to the body and a kick portion that is attached to the mount portion by a hinge.

12. The dolly apparatus of claim 7, wherein the release plate is operatively connected to the pedal by a linkage arm.

13. A method of automatically moving a dolly apparatus from an initial location to a downstream location, the method comprising:
engaging a conveyor with a synchronization leg of a dolly apparatus such that the dolly apparatus moving with the component, the dolly apparatus comprising:
a frame; and
a synchronization device mounted to the frame, the synchronization device comprising:
a body that mounts to the frame;
a synchronization leg configured to move up and down relative to the body, the synchronization leg comprising a foot configured to seat against a conveyor with the synchronization leg is a lowered position;
a pedal operatively linked to the synchronization leg such that downward movement of the pedal toward an actuated position moves the synchronization leg from a raised position to the lowered position; and
a release plate that is operatively linked to the pedal such that movement of the release plate from a locked position to a release position causes the pedal to move from the actuated position toward an initial position to raise the synchronization leg toward the raised position
actuating the release plate thereby raising the synchronization leg to the raised position and the synchronization leg releasing the conveyor.

14. The method of claim 13 further comprising rotating a drive wheel of a drive wheel assembly that is biased and configured to rotate automatically such that the dolly apparatus moves upstream relative to the conveyor with the synchronization leg in the raised position.

15. The method of claim 14, wherein the drive wheel is spring-biased to rotate automatically.
